(19) United States
(12) Patent Application Publication
(10) Pub. No.: US 2019/0109450 A1
(43) Pub. Date: Apr. 11, 2019

(54) CABLE TERMINATION ASSEMBLY AND PROCESSES FOR MAKING AND USING SAME

(71) Applicant: Schlumberger Technology Corporation, Sugar Land, TX (US)

(72) Inventors: Jared Mangum, Richmond, TX (US); Montie Wayne Morrison, Richmond, TX (US); Daniel Hogan, Missouri City, TX (US); Joseph Varkey, Sugar Land, TX (US)

(21) Appl. No.: 15/725,603

(22) Filed: Oct. 5, 2017

(51) Int. Cl. H02G 15/06; E21B 17/00; E21B 17/02; H02G 15/04; H02G 1/14

(52) U.S. Cl. CPC H02G 15/06; E21B 17/003; H02G 1/14; H02G 15/04; E21B 17/028

(57) ABSTRACT

Cable termination assemblies and processes for making and using same. In some examples, the cable termination assembly can include a lower housing and a rope socket housing can be disposed at least partially within a lower housing bore defined by a lower housing inner surface. At least one rope socket retainer can be disposed at least partially within a rope socket bore defined by an inner surface of the rope socket housing. The rope socket housing and rope socket retainer can be configured to secure the rope socket housing to a first set of armor wires of a cable, extending at least partially through the rope socket bore, while leaving interstitial gaps between individual armor wires of the first set of armor wires. A filler can be disposed between the individual armor wires of the first set of armor wires that at least partially fills the interstitial gaps.

### BACKGROUND

### Field

Embodiments described generally relate to cable termination assemblies and processes for making and using same.

### Description of the Related Art

Wireline cables can be used to provide power and/or signal transmission from well surface electrical equipment to a downhole logging tool in a wellbore. The wireline cable can be routed to a winch that can include a drum for lowering and raising the logging tool via the wireline cable.

A cable termination assembly can mechanically connect the logging tool and the wireline cable so that the wireline cable can support the downhole logging tool. Conventional cable termination assemblies allow the intrusion of fluid and/or debris into the cable end, which can lead to electrical and/or mechanical failure within the cable termination assembly and/or logging tool.

There is a need, therefore, for a cable termination assembly that can reduce or eliminate the intrusion of unwanted fluid and/or debris into the cable end.

### SUMMARY

Cable termination assemblies and processes for making and using same are provided. In some examples, the cable termination assembly can include a lower housing including a lower housing inner surface defining a lower housing bore through the lower housing. A rope socket housing can be disposed at least partially within the lower housing bore, and the rope socket housing can have a tapered rope socket housing inner surface defining a rope socket bore. At least one rope socket retainer can be disposed at least partially within the rope socket bore, and the rope socket retainer can have a tapered retainer outer surface that is complementary to the tapered rope socket housing inner surface. The rope socket retainer can have a retainer inner surface defining a retainer bore through the rope socket retainer, and the rope socket housing and rope socket retainer can be configured to secure the rope socket housing to a first set of armor wires of a cable, extending at least partially through the rope socket bore, by applying a force to the first set of armor wires between the rope socket housing inner surface and the retainer outer surface while leaving interstitial gaps between individual armor wires of the first set of armor wires. A filler can be disposed between the individual armor wires of the first set of armor wires that at least partially fills the interstitial gaps.

In some examples, a process for assembling a cable termination can include extending a cable at least partially through a rope socket bore of a rope socket. A first set of armor wires of the cable can be disposed between a rope socket housing inner surface of the rope socket and a retainer outer surface of a rope socket retainer. A force can be applied to the first set of armor wires by forcing the rope socket retainer toward the rope socket housing inner surface to secure the first set of armor wires to the rope socket while leaving interstitial gaps between individual armor wires of the first set of armor wires. At least a portion of the interstitial gaps can be filled with a filler to impede fluid flow between the rope socket housing inner surface and the retainer outer surface.

In some examples, a cable termination assembly can include a rope socket assembly which can include a rope socket housing having a first end, a second end, and a tapered rope socket housing inner surface defining a rope socket bore between the first end and the second end. A rope socket cone can define a tapered cone outer surface and a cone inner surface can define a rope socket cone bore, and the rope socket cone can be at least partially disposed within in the rope socket bore in the first end of the rope socket housing. A rope socket retainer can define a retainer outer surface and a retainer inner surface can define a retainer bore, and the rope socket retainer can be disposed at least partially in the rope socket cone bore, and the retainer bore can be sized such that at least a portion of a cable can extend therethrough. The rope socket housing inner surface and the cone outer surface can be configured to secure a first set of armor wires of the cable, and the cone inner surface and the retainer outer surface can be configured to secure a second set of armor wires of the cable. A first filler can be disposed between at least a portion of the first set of armor wires and between the rope socket housing inner surface and the cone outer surface, and can be disposed between at least a portion of the second set of armor wires and between the cone inner surface and the retainer outer surface. The first filler can be disposed such that the first filler can impede fluid flow between the rope socket housing inner surface and the cone outer surface, and can impede fluid flow between the cone inner surface and the retainer outer surface.

### BRIEF DESCRIPTION OF THE DRAWINGS

FIG. 1 depicts a cross-sectional view of an illustrative cable termination assembly secured to a cable, according to one or more embodiments described.

FIG. 2 depicts a cross-sectional view of an illustrative rope socket of the cable termination assembly shown in FIG. 1, according to one or more embodiments described.

FIG. 3 depicts a cross-sectional view of the illustrative rope socket taken along line 3-3 shown in FIG. 2, according to one or more embodiments described.

FIG. 4 depicts a cross-sectional view of an illustrative upper housing of the cable termination assembly shown in FIG. 1, according to one or more embodiments described.

### DETAILED DESCRIPTION

Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

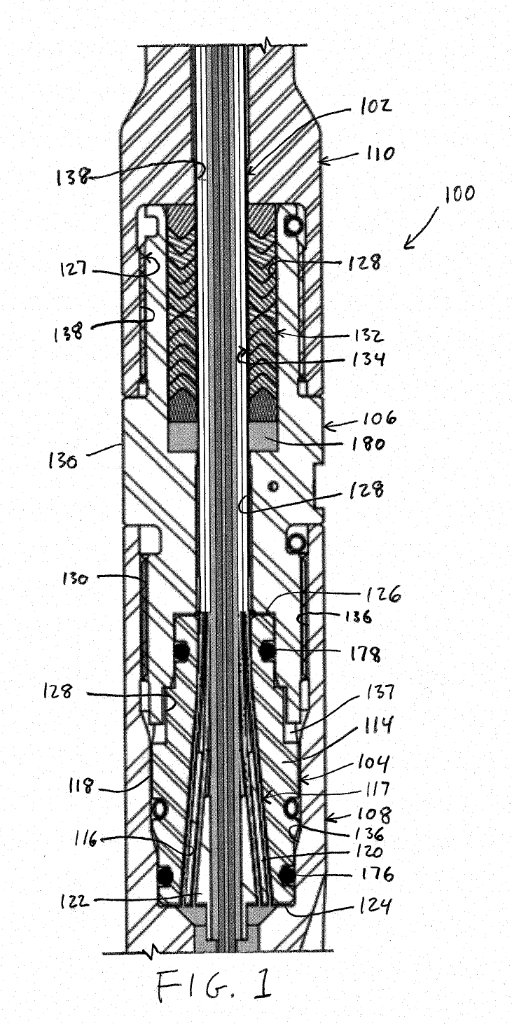

FIG. 1 depicts a cross-sectional view of an illustrative cable termination assembly 100 secured to a cable 102, according to one or more embodiments. The cable termination assembly 100 can include a rope socket 104, an upper housing 106, a lower housing 108, and a fishing neck 110. The cable termination assembly 100 can be used to secure a tool, e.g., a well logging tool, to the cable 102 to support the tool in a wellbore (not shown).

The rope socket 104 can include a rope socket housing 114 that can include a rope socket housing outer surface 118 and a rope socket housing inner surface 116 that can define a rope socket bore 117. The rope socket 104 can also include a rope socket cone 120 and a rope socket retainer 122. The rope socket housing 114 can have a first end 124 and a second end 126 and the rope socket bore 117 can extend between the first end 124 and the second end 126. In some examples, the rope socket housing inner surface 116 can taper from a relatively larger diameter at or toward the first end 124 to a relatively smaller diameter at or toward the second end 126. The rope socket cone 120 and the rope socket retainer 122 can be disposed at least partially within the rope socket bore 117. The upper housing 106 can include an upper housing outer surface 130 and an upper housing inner surface 128 that can define an upper housing bore 127. The cable termination assembly 100 can include a cable seal 132 that can define a cable seal bore 134 and can be disposed at least partially within the upper housing bore 127. The lower housing 108 can include a lower housing inner surface 136 that can define a lower housing bore 137, and the fishing neck 110 can define a fishing neck bore 138.

In one or more examples, the rope socket 104 can be disposed at least partially within the lower housing bore 137 and at least partially within the upper housing bore 127. In one or more examples, the upper housing 106 can be disposed at least partially within the lower housing bore 137 and at least partially within the fishing neck bore 138. In one or more examples, the upper housing 106 can be coupled to the lower housing 108, and the rope socket 104 can be secured within the lower housing bore 137 and the upper housing bore 127 by the coupling of the upper housing 106 and the lower housing 108. In one or more examples, the upper housing 106 and the lower housing 108 can be coupled to one another, e.g., via a threaded connection. In one or more examples, when the cable termination assembly 100 is secured to the cable 102, the cable 102 can extend through the fishing neck bore 138, the cable seal bore 134, the upper housing bore 127, the rope socket bore 117, and the lower housing bore 137.

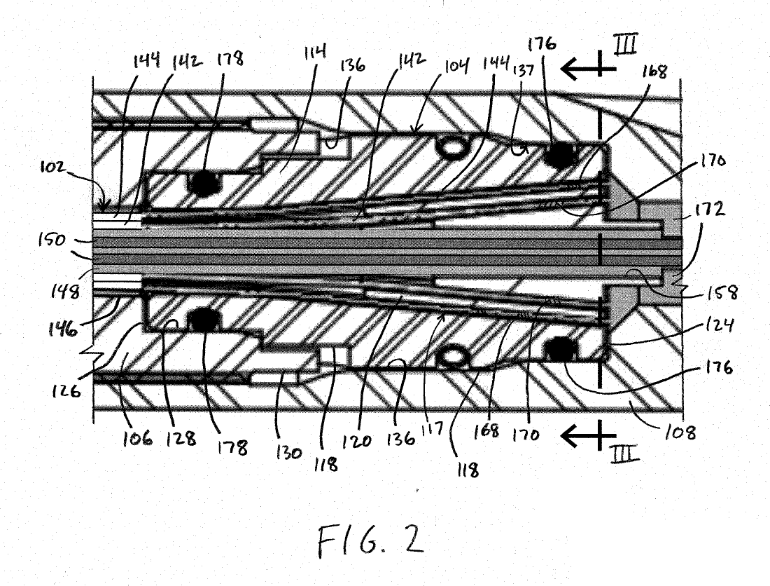

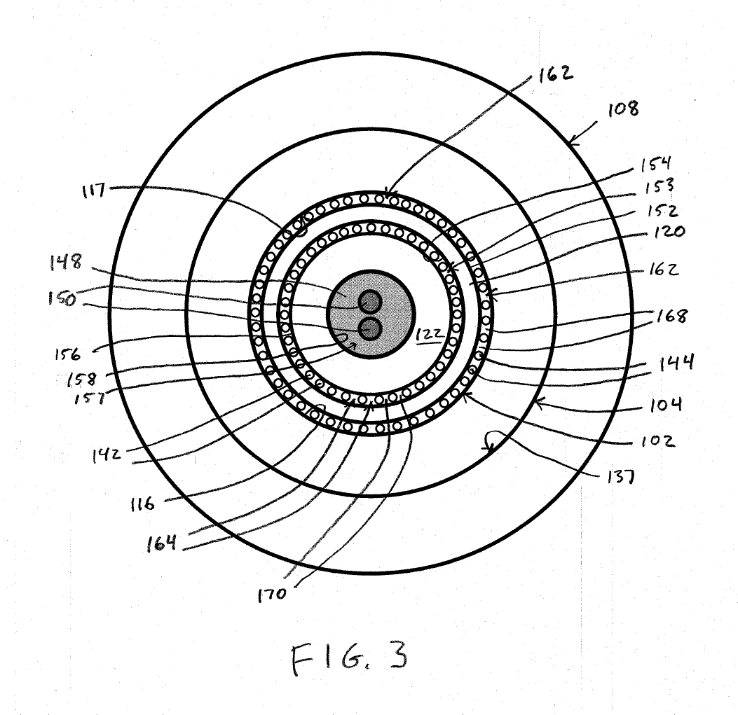

FIG. 2 depicts a cross-sectional view of the illustrative rope socket 104 shown in FIG. 1, according to one or more embodiments. FIG. 3 depicts a cross-sectional view of the of the illustrative rope socket 104 taken along the line 3-3 shown in FIG. 2, according to one or more embodiments. In one or more examples, the cable 102 can include one or more sets of armor wires (two sets are shown, i.e., a first set of armor wires 142 and a second set of armor wires 144). In one or more examples, the cable 102 can also include an outer surface 146, an inner insulation 148, and one or more inner electrical conductors 150. In some examples, the cable 102 can be or include a coaxial cable. The first set of armor wires 142 can be wrapped around the inner insulation 148 and the second set of armor wires 144 can be wrapped around the first set of armor wires 142. In some examples, one set of armor wires can be helically wound in one direction along the length of the cable 102 and the other set of armor wires can be helically wound in an opposite direction along the length of the cable 102.

The rope socket 104 can be secured to the cable 102. The rope socket cone 120 can include a cone outer surface 152 and a cone inner surface 154 that can define a rope socket cone bore 153. In some examples, the cone outer surface 152 can include a taper and the cone inner surface 154 can include a taper. In one or more examples, the cone outer surface 152 can be complementary or substantially complimentary to the taper of the rope socket housing inner surface 116. In one or more examples, the second set of armor wires 144 can be disposed within and extend at least partially through the rope socket bore 117 between the cone outer surface 152 and the rope socket housing inner surface 116. In some examples, the second set of armor wires 144 can be compressed between the rope socket housing inner surface 116 and the cone outer surface 152 to secure the second set of armor wires 144 to the rope socket 104. For example, a compressive force can be applied to the second set of armor wires 144, tending toward compressing the second set of armor wires 144 between the rope socket housing inner surface 116 and the cone outer surface 152 to secure the second set of armor wires 144 to the rope socket 104. In some examples, the compressive force can be at least partially applied by pulling the cable 102 in the direction of the fishing neck 110 (FIG. 1) relative to the rope socket 104, e.g., by supporting the cable termination assembly 110 with the cable 102, which can cause the rope socket cone 120 to act as a wedge.

The rope socket retainer 122 can include a retainer outer surface 156, and a retainer inner surface 158 that can define a retainer bore 157. The retainer outer surface 156 can include a taper that can be complementary or substantially complimentary to a taper of the cone inner surface 154 and/or to a taper of the rope socket housing inner surface 116. In one or more examples, the first set of armor wires 142 can be disposed within and extend at least partially through the rope socket cone bore 153 of the rope socket cone 120 and in between the retainer outer surface 156 and the cone inner surface 154. In some examples, the first set of armor wires 142 can be compressed between the cone inner surface 154 and the retainer outer surface 156 to secure the first set of armor wires 142 to the rope socket 104. For example, a compressive force can be applied to the first set of armor wires 142, tending toward compressing the first set of armor wires 142 between the cone inner surface 154 and the retainer outer surface 156 to secure the first set of armor wires 142 to the rope socket 104. In some examples, the compressive force can be at least partially applied by pulling the cable 102 toward the fishing neck 110 (FIG. 1) relative to the rope socket 104, which can cause the rope socket retainer 122 to act as a wedge in the rope socket cone bore 153. In one or more examples, the rope socket 104 can be free from rope socket cones and the rope socket retainer 122 can act as a wedge and can cooperate with the rope socket housing inner surface 116 to secure armor wires. In one or more examples, the rope socket retainer 122 can cooperate to secure the first set of armor wires 142 and/or the second set of armor wires 144 with or without rope socket cone 120. In one or more examples, the rope socket 104 can be free of rope socket cones, can include one rope socket cone, or can include a plurality of rope socket cones. In one or more examples, the armor wires can be equally, or substantially equally distributed in the rope socket and can equally, or substantially equally share the load of the downhole tool.

In some examples, the cable 102 can be a wireline cable and can be used for well logging. The first set of armor wires 142 and/or second set of armor wires 144 can be or can include tensile members that can be load bearing and can be used to support a downhole tool string. The rope socket 104 can connect armor wires of the wireline cable to load bearing components of the downhole tool string. Cable 102 can include one or more sets of armor wires. The cable 102 can be a jacketed cable or a non-jacketed cable.

When the second set of armor wires 144 are secured to the rope socket 104, there can be interstitial gaps 162 between the rope socket housing inner surface 116, the cone outer surface 152 and the second set of armor wires 144, as shown in FIG. 3. When the first set of armor wires 142 are secured to the rope socket 104, there can be interstitial gaps 164 between the cone inner surface 154, the retainer outer surface 156 and the first set of armor wires 142. The interstitial gaps 162/164 can allow well fluid and other debris to enter the cable termination which can have a negative impact on exposed armor wires, electrical connections, and/or mechanical connections within the cable termination assembly 100. In the case of a polymer jacketed cable, the open end of a cable (created by the rope socket) can also be the means of fluid/gas entry into the cable.

In one or more examples, a first filler 168 can be disposed, at least partially, in the interstitial gaps 162, and/or a first filler 170 can be disposed, at least partially, in the interstitial gaps 164. The first filler 168 can be the same or different material than the first filler 170. In one or more examples, the first filler 168 can completely fill the interstitial gaps 162, and the first filler 170 can completely fill the interstitial gaps 164. The first filler 168 can impede fluid, either entirely or in part, from entering into the interstitial gaps 162, and first filler 170 can impede fluid, either entirely or in part, from entering into the interstitial gaps 164. In one or more examples, the first filler 168 and/or the first filler 170 can impede fluid from entering interstitial gaps 162/164 from the lower housing bore 137. In one or more examples, a first filler 172 (FIG. 2) can be disposed in the lower housing bore 137 to impede fluid flow, either entirely or in part, between the lower housing inner surface 136 and the rope socket housing outer surface 118. The first filler 172 can be the same or a different material that the first filler 168 and/or the first filler 170. In one or more examples, the first filler 172 can be or can include a pressure compensating fluid to compensate against well pressure and can substantially fill the lower housing bore 137 such that little or no air or other fluid remains in the lower housing bore 137.

The cable termination assembly 100 can include a lower rope socket housing seal 176 (FIG. 2). The lower rope socket housing seal 176 can be disposed between the rope socket housing outer surface 118 and the lower housing inner surface 136. The lower rope socket housing seal 176 can be disposed at or near the first end 124 of the rope socket housing 114. The lower rope socket housing seal 176 can impede fluid, either entirely or in part, from flowing between the rope socket housing outer surface 118 and the lower housing inner surface 136. In one or more examples, the lower rope socket housing seal 176, the first filler 168, and the first filler 170 can impede fluid flow from the first end 124 of the rope socket housing 114 to the second end 126 of the rope socket housing 114. In one or more examples, the first filler 172 can impede fluid, either entirely or in part, from flowing between the cable 102 and the retainer inner surface 158. In one or more examples, the lower rope socket housing seal 176 can impede the first filler 172 in the lower housing bore 137, either entirely or in part, from flowing between the lower housing inner surface 136 and the rope socket housing outer surface 118. In one or more examples, the lower rope socket housing seal 176 can be used to impede first filler 168 and/or first filler 170 from flowing around the rope socket housing 114 when the first filler 168 is inserted into the interstitial gaps 162 and/or the first filler 170 is inserted into the interstitial gaps 164.

The cable termination assembly 100 can include an upper rope socket housing seal 178. The upper rope socket housing seal 178 can be disposed between the rope socket housing outer surface 118 and the upper housing inner surface 128. The upper rope socket housing seal 178 can be disposed at or near the second end 126 of the rope socket housing 114. The upper rope socket housing seal 178 can impede fluid, either entirely or in part, from flowing between the rope socket housing outer surface 118 and the upper housing inner surface 128. In one or more examples, the upper rope socket housing seal 178, the first filler 168, and the first filler 170 can impede fluid flow from the second end 126 of the rope socket housing 114 to the first end 124 of the rope socket housing 114. In one or more examples, the upper rope socket housing seal 178 can impede fluid from flowing from and/or to space between the cable outer surface 146 and the upper housing inner surface 128, and space between the upper housing outer surface 130 and lower housing inner surface 136. In one or more examples, the upper rope socket housing seal 178 and the lower rope socket housing seal 176 can impede fluid flow from space between the upper housing outer surface 130 and the lower housing inner surface 136 to the first end 124 and the second end 126 of the rope socket housing 114.

In one or more embodiments, the lower rope socket housing seal 176 and/or the upper rope socket housing seal 178 can be an elastomer piston seal, an O-ring seal, a metal to metal seal, and/or other type of seal. The lower rope socket housing seal 176 and/or the upper rope socket housing seal 178 can be, or include, face seals, and can be closer and/or further from the rope socket housing ends 124/126 and can be disposed on one or both of the rope socket housing end 124 and/or rope socket housing end 126. The upper rope socket housing seal 178 and/or the lower rope socket housing seal 176 can each include one or more seals.

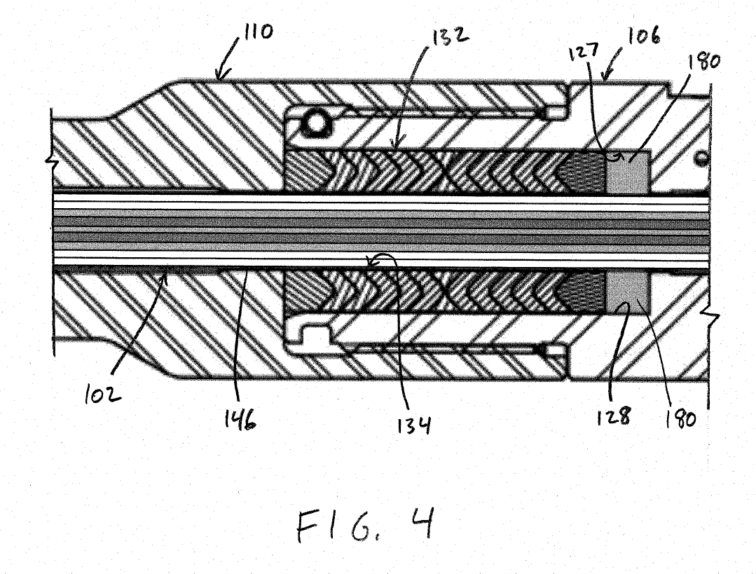

FIG. 4 depicts a cross-sectional view of the illustrative upper housing 106 of the cable termination assembly 100 shown in FIG. 1, according to one or more embodiments. The cable termination assembly 100 can include the cable seal 132, which can be disposed in the upper housing bore 127 of the upper housing 106. The cable seal 132 can include the cable seal bore 134 which can be sized to allow the cable 102 to extend therethrough. The cable seal 132 can seal between the cable outer surface 146 and the upper housing inner surface 128 to impede fluid flow, either entirely or in part, around the cable 102. In some examples, the cable seal 132 can be, or include a chevron type seal and can be or include a seal stack, such as packing rings, or other sealing mechanisms can also be employed. The cable seal 132 can be configured for seal around a jacketed cable or can be a type of packing to seal around a non-jacketed cable. The cable termination assembly 100 can include a second filler 180 that can be disposed between the cable outer surface 146 and the upper housing inner surface 128, and can be adjacent to the cable seal 132. In one or more examples, the second filler 180 can be disposed to assist the cable seal 132 with sealing between the cable outer surface 146 and the upper housing inner surface 128.

The cable seal 132, the lower rope socket housing seal 176 and/or the upper rope socket housing seal 178 can be fabricated from one or more elastomeric materials, including, but not limited to, hydrogenated nitrile or HNBR (hydrogenated acrylonitrile butadiene), tetrafluoroethylene, copolymers of hexafluoropropylene (HFP) and vinylidene fluoride (VDF), terpolymers of tetrafluoroethylene (TFE), vinylidene fluoride (VDF), and hexafluoropropylene (HFP), perfluoromethylvinylether (PMVE), perfluoroelastomers, or any combination thereof. Suitable commercially available elastomeric materials can include, but are not limited to, those sold under the tradenames VITON®, KALREZ®, and CHEMRAZ®.

In one or more examples, the cable termination assembly 100 can include the cable seal 132, the upper rope socket housing seal 178, and the lower rope socket housing seal 176. The cable seal 132, upper rope socket housing seal 178, and lower rope socket housing seal 176 can impede fluid flow, and can seal the rope socket 104 to reduce or prevent fluid and/or debris or other contaminants from intrusion into the rope socket 104. A sealed rope socket can seal a wireline cable termination/head and can prevent undesirable fluid entry into a wireline termination. In one or more examples, the cable seal 132 can seal between the upper housing inner surface 128 and polymer filled and jacketed cables outer surface 146.

In one or more examples, the first filler 168, the first filler 170, the first filler 172 and/or the second filler 180 can be, or include, one or more of a polymer, epoxy, grease, oil, a non-corrosive material, and/or other sealing medium. In one or more examples, the fillers 168, 170, 172, and 180 can be or include, the same material. In one or more examples, the fillers 168, 170, 172, and 180 can be, or include, a material that is non-corrosive to the armor wires and that can be intentionally added to prevent the intrusion of unwanted materials into the cable termination assembly 100. In one or more examples, the fillers 168, 170, 172, and 180 can be added during the assembly of the cable termination assembly 100. In one or more examples, the first filler 168, the first filler 170, the first filler 172, and/or the second filler 180 can be pressure compensating using a piston, bellows, differential density fluids, an opening to well fluid, and/or another pressure compensating device, and can maintain a differential pressure across the rope socket. In one or more examples, the rope socket 104 can be sealed in order to take full differential pressure.

In one or more examples, the first filler 168, the first filler 170, the first filler 172, the second filler 180, the lower rope socket housing seal 176, the upper rope socket housing seal 178, and/or the cable seal 132 can form a liquid tight seal, a gas tight seal, or a liquid and gas tight seal. In one or more example, the first filler 168, the first filler 170, the first filler 172, the second filler 180, the lower rope socket housing seal 176, the upper rope socket housing seal 178, and/or the cable seal 132 can prevent debris and/or a fluid, e.g., a downhole gas and/or a downhole liquid, from contacting the first set of armor wires 142 and/or the second set of armor wires 144 within the rope socket 104. Illustrative downhole fluids can include, but are not limited to, water-based drilling fluids, base fluids (e.g., fresh water, sea water, brine, saturated brine, and/or formate brine) used in non-dispersed systems containing natural clays or in dispersed systems containing chemical dispersants such as lignosulfonates, lignitic additives, tannins, and/or caustic soda; polymer-based drilling fluids; oil-based drilling fluids (e.g., diesel, mineral oil, and/or linear olefins and paraffins); synthetic-based drilling fluids that can include linear alpha-olefins (LAO) and isomerized olefins (IO); pneumatic-drilling fluids (e.g., air or other gases); and subterranean hydrocarbon liquids, hydrocarbon gases, inorganic compounds, and/or organic compounds; and mixture thereof.

The cable termination can be assembled by extending a cable 102 at least partially through the rope socket bore 117 of the rope socket 104. The first set of armor wires 142 can be disposed between the rope socket housing inner surface 116 and the retainer outer surface 156. A compressive force can be applied to the first set of armor wires 142 and can force the rope socket retainer 122 toward the rope socket housing inner surface 116 to secure the first set of armor wires 142 to the rope socket 104 while leaving the interstitial gaps 164 between individual armor wires of the first set of armor wires 142. At least a portion of the interstitial gaps 164 can be filled with the first filler 170 to impede fluid flow between the rope socket housing inner surface 116 and the retainer outer surface 156.

Embodiments of the present disclosure further relate to any one or more of the following paragraphs:

1. A cable termination assembly, comprising: a lower housing including a lower housing inner surface defining a lower housing bore through the lower housing; a rope socket housing disposed at least partially within the lower housing bore, wherein the rope socket housing has a tapered rope socket housing inner surface defining a rope socket bore; at least one rope socket retainer disposed at least partially within the rope socket bore, wherein the rope socket retainer has a tapered retainer outer surface that is complementary to the tapered rope socket housing inner surface, wherein the rope socket retainer has a retainer inner surface defining a retainer bore through the rope socket retainer, and wherein the rope socket housing and rope socket retainer are configured to secure the rope socket housing to a first set of armor wires of a cable, extending at least partially through the rope socket bore, by applying a force to the first set of armor wires between the rope socket housing inner surface and the retainer outer surface while leaving interstitial gaps between individual armor wires of the first set of armor wires; and a filler disposed between the individual armor wires of the first set of armor wires that at least partially fills the interstitial gaps.

2. The cable termination assembly according to paragraph 1, wherein the filler completely fills the interstitial gaps.

3. The cable termination assembly according to paragraph 1 or 2, wherein the filler is configured to impede fluid flow between the rope socket housing inner surface and the retainer outer surface.

4. The cable termination assembly according to any one of paragraphs 1 to 3, wherein the rope socket housing has a rope socket housing outer surface, the cable termination assembly further comprising: a lower rope socket housing seal disposed between the rope socket housing outer surface and the lower housing inner surface, wherein the lower rope socket housing seal is configured to impede fluid flow between the rope socket housing outer surface and the lower housing inner surface.

5. The cable termination assembly according to any one of paragraphs 1 to 4, further comprising: an upper housing having an upper housing inner surface defining an upper housing bore through the upper housing, wherein the rope socket housing is disposed at least partially within the upper housing bore; and an upper rope socket housing seal disposed between the rope socket housing outer surface and the upper housing inner surface, wherein the upper rope socket housing seal is configured to impede fluid flow between the rope socket housing outer surface and the upper housing inner surface.

6. The cable termination assembly according to paragraph 5, wherein the lower housing is substantially filled with the filler and the filler provides pressure compensation.

7. The cable termination assembly according to any one of paragraphs 1 to 6, wherein the filler comprises a polymer, an epoxy, a grease, an oil, or a mixture thereof.

8. The cable termination assembly according to any one of paragraphs 1 to 6, wherein the filler comprises an epoxy.

9. The cable termination assembly according to any one of paragraphs 1 to 8, further comprising: an upper housing having an upper housing inner surface defining an upper housing bore through the upper housing, wherein the rope socket housing is disposed at least partially within the upper housing bore; and a cable seal disposed at least partially within the upper housing bore and configured to impede fluid flow between the upper housing inner surface and the cable when the cable is extended through the upper housing bore.

10. The cable termination assembly according to any one of paragraphs 1 to 9, further comprising: a rope socket cone disposed at least partially between the rope socket housing inner surface and the retainer outer surface, wherein the rope socket cone has a cone outer surface and a cone inner surface, and wherein the rope socket housing, rope socket cone, and rope socket retainer are configured to secure a second set of armor wires between the rope socket housing inner surface and the cone outer surface, and are configured to secure the first set of armor wires of the cable between the cone inner surface and the retainer outer surface, and wherein the filler is disposed between the rope socket housing inner surface and the cone outer surface, and the filler is disposed between the cone inner surface and the retainer outer surface.

11. A process for assembling a cable termination, comprising: extending a cable at least partially through a rope socket bore of a rope socket; disposing a first set of armor wires of the cable between a rope socket housing inner surface of the rope socket and a retainer outer surface of a rope socket retainer; applying a force to the first set of armor wires by forcing the rope socket retainer toward the rope socket housing inner surface to secure the first set of armor wires to the rope socket while leaving interstitial gaps between individual armor wires of the first set of armor wires; and filling at least a portion of the interstitial gaps with a filler to impede fluid flow between the rope socket housing inner surface and the retainer outer surface.

12. The process according to paragraph 11, further comprising: disposing a rope socket cone of the rope socket between the rope socket housing inner surface and the retainer outer surface, the rope socket cone including a cone outer surface and a cone inner surface; disposing a second set of armor wires of the cable between the rope socket housing inner surface and the cone outer surface, and wherein the first set of armor wires are disposed between the cone inner surface and the retainer outer surface, and wherein filling the interstitial gap includes at least partially filling between the rope socket housing inner surface and the cone outer surface, and between the cone inner surface and the retainer outer surface to impede fluid flow between the rope socket housing inner surface and the cone outer surface, and between the cone inner surface and the retainer outer surface.

13. The process according to paragraph 11 or 12, further comprising: disposing the rope socket at least partially in a lower housing; and forming a seal between a rope socket housing outer surface and a lower housing inner surface to impede fluid flow between the rope socket housing outer surface and the lower housing inner surface.

14. The process according to paragraph 13, further comprising: extending the cable at least partially through an upper housing; and forming a seal between an outer surface of the cable and an inner surface of the upper housing to impede fluid flow between the upper housing inner surface and the cable outer surface.

15. The process according to paragraph 13 or 14, wherein the filler is filled into the lower housing as a pressure compensating fluid, wherein the sealing between the rope socket and the lower housing impedes the filler from flowing between the rope socket and the lower housing.

16. A cable termination assembly, comprising: a rope socket assembly comprising: a rope socket housing having a first end, a second end, and a tapered rope socket housing inner surface defining a rope socket bore between the first end and the second end; a rope socket cone defining a tapered cone outer surface and a cone inner surface defining a rope socket cone bore, wherein the rope socket cone is at least partially disposed within in the rope socket bore in the first end of the rope socket housing; a rope socket retainer defining a retainer outer surface and a retainer inner surface defining a retainer bore, wherein the rope socket retainer is disposed at least partially in the rope socket cone bore, and wherein the retainer bore is sized such that at least a portion of a cable can extend therethrough, and wherein the rope socket housing inner surface and the cone outer surface are configured to secure a first set of armor wires of the cable, and wherein the cone inner surface and the retainer outer surface are configured to secure a second set of armor wires of the cable; and a first filler disposed between at least a portion of the first set of armor wires and between the rope socket housing inner surface and the cone outer surface, and disposed between at least a portion of the second set of armor wires and between the cone inner surface and the retainer outer surface, and wherein the first filler is disposed such that the first filler impedes fluid flow between the rope socket housing inner surface and the cone outer surface, and impedes fluid flow between the cone inner surface and the retainer outer surface.

17. The cable termination assembly according to paragraph 16, further comprising: a lower housing including a lower housing inner surface defining a lower housing bore, wherein the rope socket housing is at least partially disposed within the lower housing bore; and a lower rope socket housing seal disposed between the rope socket housing outer surface and the lower housing inner surface, wherein the lower rope socket housing seal is configured to impede fluid flow between the rope socket housing outer surface and the lower housing inner surface.

18. The cable termination assembly according to paragraph 16 or 17, further comprising: an upper housing including an upper housing inner surface defining a upper housing bore that is sized such that at least a portion of the cable can extend therethrough, and wherein the rope socket housing is at least partially disposed within the upper housing bore; and a cable seal disposed at least partially within the upper housing bore, wherein the cable seal is configured to seal around the cable when the cable is extended through the upper housing bore to impede fluid flow between an outer surface of the cable and the upper housing inner surface.

19. The cable termination assembly according to paragraph 18, further comprising: an upper rope socket housing seal disposed between the rope socket housing outer surface and the upper housing inner surface, the upper rope socket housing seal configured to impede fluid flow between the rope socket housing outer surface and the upper housing inner surface.

20. The cable termination assembly according to paragraph 18, further comprising: a second filler disposed in the upper housing bore to impede fluid flow between the outer surface of the cable and the upper housing inner surface.

21. A cable termination assembly, comprising: a lower housing including a lower housing inner surface defining a lower housing bore through the lower housing; a rope socket housing disposed at least partially within the lower housing bore, wherein the rope socket housing has a tapered rope socket housing inner surface defining a rope socket bore; at least one rope socket retainer disposed at least partially within the rope socket bore, wherein the rope socket retainer has a tapered retainer outer surface that is complementary to the tapered rope socket housing inner surface, and wherein the rope socket retainer has a retainer inner surface defining a retainer bore through the rope socket retainer, and wherein the rope socket housing and rope socket retainer are configured to secure the rope socket housing to a first set of armor wires of a cable, extending at least partially through the rope socket bore, by applying a force to the first set of armor wires between the rope socket housing inner surface and the retainer outer surface while leaving interstitial gaps between individual armor wires of the first set of armor wires, wherein the rope socket housing has a rope socket housing outer surface; and a lower rope socket housing seal disposed between the rope socket housing outer surface and the lower housing inner surface, wherein the lower rope socket housing seal is configured to impede fluid flow between the rope socket housing outer surface and the lower housing inner surface.

22. A cable termination assembly, comprising: a lower housing including a lower housing inner surface defining a lower housing bore through the lower housing; a rope socket housing disposed at least partially within the lower housing bore, wherein the rope socket housing has a tapered rope socket housing inner surface defining a rope socket bore; at least one rope socket retainer disposed at least partially within the rope socket bore, wherein the rope socket retainer has a tapered retainer outer surface that is complementary to the tapered rope socket housing inner surface, and wherein the rope socket retainer has a retainer inner surface defining a retainer bore through the rope socket retainer, and wherein the rope socket housing and rope socket retainer are configured to secure the rope socket housing to a first set of armor wires of a cable, extending at least partially through the rope socket bore, by applying a force to the first set of armor wires between the rope socket housing inner surface and the retainer outer surface while leaving interstitial gaps between individual armor wires of the first set of armor wires, wherein the rope socket housing has a rope socket housing outer surface; an upper housing having an upper housing inner surface defining an upper housing bore through the upper housing, wherein the rope socket housing is disposed at least partially within the upper housing bore; and an upper rope socket housing seal disposed between the rope socket housing outer surface and the upper housing inner surface, wherein the upper rope socket housing seal is configured to impede fluid flow between the rope socket housing outer surface and the upper housing inner surface.

23. The cable termination assembly according to paragraph 21 or 22, further comprising a filler disposed between the individual armor wires of the first set of armor wires that at least partially fills the interstitial gaps.

24. The cable termination assembly according to any one of paragraphs 21 to 23, wherein the filler completely fills the interstitial gaps.

25. The cable termination assembly according to any one of paragraphs 21 to 24, wherein the filler is configured to impede fluid flow between the rope socket housing inner surface and the retainer outer surface.

26. The cable termination assembly according to any one of paragraphs 21 to 25, wherein the lower housing is substantially filled with the filler and the filler provides pressure compensation.

27. The cable termination assembly according to any one of paragraphs 21 to 26, wherein the filler comprises a polymer, an epoxy, a grease, an oil, or a mixture thereof.

28. The cable termination assembly according to any one of paragraphs 21 to 27, wherein the filler comprises an epoxy.

29. The cable termination assembly according to any one of paragraphs 21 to 28, further comprising: a rope socket cone disposed at least partially between the rope socket housing inner surface and the retainer outer surface, wherein the rope socket cone has a cone outer surface and a cone inner surface, and wherein the rope socket housing, rope socket cone, and rope socket retainer are configured to secure a second set of armor wires between the rope socket housing inner surface and the cone outer surface, and are configured to secure the first set of armor wires of the cable between the cone inner surface and the retainer outer surface, and wherein the filler is disposed between the rope socket housing inner surface and the cone outer surface, and the filler is disposed between the cone inner surface and the retainer outer surface.

Although the preceding description has been described herein with reference to particular means, materials, and embodiments, it is not intended to be limited to the particulars disclosed herein; rather, it extends to all functionally equivalent structures, processes, and uses, such as are within the scope of the appended claims.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A cable termination assembly, comprising:
a lower housing including a lower housing inner surface defining a lower housing bore through the lower housing;
a rope socket housing disposed at least partially within the lower housing bore, wherein the rope socket housing has a tapered rope socket housing inner surface defining a rope socket bore;
at least one rope socket retainer disposed at least partially within the rope socket bore, wherein the rope socket retainer has a tapered retainer outer surface that is complementary to the tapered rope socket housing inner surface, wherein the rope socket retainer has a retainer inner surface defining a retainer bore through the rope socket retainer, and wherein the rope socket housing and rope socket retainer are configured to secure the rope socket housing to a first set of armor wires of a cable, extending at least partially through the rope socket bore, by applying a force to the first set of armor wires between the rope socket housing inner surface and the retainer outer surface while leaving interstitial gaps between individual armor wires of the first set of armor wires; and
a filler disposed between the individual armor wires of the first set of armor wires that at least partially fills the interstitial gaps.

2. The cable termination assembly of claim 1, wherein the filler completely fills the interstitial gaps.

3. The cable termination assembly of claim 1, wherein the filler is configured to impede fluid flow between the rope socket housing inner surface and the retainer outer surface.

4. The cable termination assembly of claim 1, wherein the rope socket housing has a rope socket housing outer surface, the cable termination assembly further comprising:
a lower rope socket housing seal disposed between the rope socket housing outer surface and the lower housing inner surface, wherein the lower rope socket housing seal is configured to impede fluid flow between the rope socket housing outer surface and the lower housing inner surface.

5. The cable termination assembly of claim 1, further comprising:
an upper housing having an upper housing inner surface defining an upper housing bore through the upper housing, wherein the rope socket housing is disposed at least partially within the upper housing bore; and
an upper rope socket housing seal disposed between the rope socket housing outer surface and the upper housing inner surface, wherein the upper rope socket housing seal is configured to impede fluid flow between the rope socket housing outer surface and the upper housing inner surface.

6. The cable termination assembly of claim 5, wherein the lower housing is substantially filled with the filler and the filler provides pressure compensation.

7. The cable termination assembly of claim 1, wherein the filler comprises a polymer, an epoxy, a grease, an oil, or a mixture thereof.

8. The cable termination assembly of claim 1, wherein the filler comprises an epoxy.

9. The cable termination assembly of claim 1, further comprising:
an upper housing having an upper housing inner surface defining an upper housing bore through the upper housing, wherein the rope socket housing is disposed at least partially within the upper housing bore; and
a cable seal disposed at least partially within the upper housing bore and configured to impede fluid flow between the upper housing inner surface and the cable when the cable is extended through the upper housing bore.

10. The cable termination assembly of claim 1, further comprising:
a rope socket cone disposed at least partially between the rope socket housing inner surface and the retainer outer surface, wherein the rope socket cone has a cone outer surface and a cone inner surface, and wherein the rope socket housing, rope socket cone, and rope socket retainer are configured to secure a second set of armor wires between the rope socket housing inner surface and the cone outer surface, and are configured to secure the first set of armor wires of the cable between the cone inner surface and the retainer outer surface, and wherein the filler is disposed between the rope socket housing inner surface and the cone outer surface, and the filler is disposed between the cone inner surface and the retainer outer surface.

11. A process for assembling a cable termination, comprising:
extending a cable at least partially through a rope socket bore of a rope socket;
disposing a first set of armor wires of the cable between a rope socket housing inner surface of the rope socket and a retainer outer surface of a rope socket retainer;
applying a force to the first set of armor wires by forcing the rope socket retainer toward the rope socket housing inner surface to secure the first set of armor wires to the rope socket while leaving interstitial gaps between individual armor wires of the first set of armor wires; and
filling at least a portion of the interstitial gaps with a filler to impede fluid flow between the rope socket housing inner surface and the retainer outer surface.

12. The process of claim 11, further comprising:
disposing a rope socket cone of the rope socket between the rope socket housing inner surface and the retainer outer surface, the rope socket cone including a cone outer surface and a cone inner surface;
disposing a second set of armor wires of the cable between the rope socket housing inner surface and the cone outer surface, and wherein the first set of armor wires are disposed between the cone inner surface and the retainer outer surface, and wherein filling the interstitial gap includes at least partially filling between the rope socket housing inner surface and the cone outer surface, and between the cone inner surface and the retainer outer surface to impede fluid flow between the rope socket housing inner surface and the cone outer surface, and between the cone inner surface and the retainer outer surface.

13. The process of claim 11, further comprising:
disposing the rope socket at least partially in a lower housing; and
forming a seal between a rope socket housing outer surface and a lower housing inner surface to impede fluid flow between the rope socket housing outer surface and the lower housing inner surface.

14. The process of claim 13, further comprising:
extending the cable at least partially through an upper housing; and
forming a seal between an outer surface of the cable and an inner surface of the upper housing to impede fluid flow between the upper housing inner surface and the cable outer surface.

15. The process of claim 13, wherein the filler is filled into the lower housing as a pressure compensating fluid, wherein the sealing between the rope socket and the lower housing impedes the filler from flowing between the rope socket and the lower housing.

16. A cable termination assembly, comprising:
a rope socket assembly comprising:
a rope socket housing having a first end, a second end, and a tapered rope socket housing inner surface defining a rope socket bore between the first end and the second end;
a rope socket cone defining a tapered cone outer surface and a cone inner surface defining a rope socket cone bore, wherein the rope socket cone is at least partially disposed within in the rope socket bore in the first end of the rope socket housing;
a rope socket retainer defining a retainer outer surface and a retainer inner surface defining a retainer bore, wherein the rope socket retainer is disposed at least partially in the rope socket cone bore, and wherein the retainer bore is sized such that at least a portion of a cable can extend therethrough, and wherein the rope socket housing inner surface and the cone outer surface are configured to secure a first set of armor wires of the cable, and wherein the cone inner surface and the retainer outer surface are configured to secure a second set of armor wires of the cable; and
a first filler disposed between at least a portion of the first set of armor wires and between the rope socket housing inner surface and the cone outer surface, and disposed between at least a portion of the second set of armor wires and between the cone inner surface and the retainer outer surface, and wherein the first filler is disposed such that the first filler impedes fluid flow between the rope socket housing inner surface and the cone outer surface, and impedes fluid flow between the cone inner surface and the retainer outer surface.

17. The cable termination assembly of claim 16, further comprising:
a lower housing including a lower housing inner surface defining a lower housing bore, wherein the rope socket housing is at least partially disposed within the lower housing bore; and
a lower rope socket housing seal disposed between the rope socket housing outer surface and the lower housing inner surface, wherein the lower rope socket housing seal is configured to impede fluid flow between the rope socket housing outer surface and the lower housing inner surface.

18. The cable termination assembly of claim 16, further comprising:
an upper housing including an upper housing inner surface defining a upper housing bore that is sized such that at least a portion of the cable can extend therethrough, and wherein the rope socket housing is at least partially disposed within the upper housing bore; and
a cable seal disposed at least partially within the upper housing bore, wherein the cable seal is configured to seal around the cable when the cable is extended through the upper housing bore to impede fluid flow between an outer surface of the cable and the upper housing inner surface.

19. The cable termination assembly of claim 18, further comprising:
an upper rope socket housing seal disposed between the rope socket housing outer surface and the upper housing inner surface, the upper rope socket housing seal configured to impede fluid flow between the rope socket housing outer surface and the upper housing inner surface.

20. The cable termination assembly of claim 18, further comprising:
a second filler disposed in the upper housing bore to impede fluid flow between the outer surface of the cable and the upper housing inner surface.
